(19) United States
(12) Patent Application Publication
(10) Pub. No.: US 2017/0161255 A1
(43) Pub. Date: Jun. 8, 2017

(54) EXTRACTING ENTITIES FROM NATURAL LANGUAGE TEXTS

(71) Applicant: ABBYY InfoPoisk LLC, Moscow (RU)

(72) Inventors: Anatoly Starostin, Moscow (RU); Tatiana Danielyan, Moscow (RU); Ivan Smurov, Moscow (RU)

(21) Appl. No.: 14/974,578

(22) Filed: Dec. 18, 2015

(30) Foreign Application Priority Data
Dec. 2, 2015 (RU) 2015151699

(51) Int. Cl. G06F 17/27; G06F 17/30

(52) U.S. Cl. CPC G06F 17/278; G06F 17/2785; G06F 17/271; G06F 17/30705

(57) ABSTRACT

Systems and methods for creating ontologies by analyzing natural language texts. An example method comprises: receiving identifiers of a first plurality of word groups within a natural language text, each word group comprising one or more natural language words; associating an object represented by each word group with a concept of an ontology; identifying, within the natural language text, a second plurality of word groups, wherein each word group of the second plurality of word groups is associated with the concept of the ontology; responsive to receiving a confirmation that a word group of the second plurality of word groups represents an object associated with the concept of the ontology, modifying a parameter of a classification model that produces a value reflecting a degree of association of a given object with the concept of the ontology.

### CROSS REFERENCE TO RELATED APPLICATIONS

The present application claims the benefit of priority under 35 USC 119 to Russian Patent Application No. 2015151699, filed Dec. 2, 2015; the disclosure of which is herein incorporated by reference in its entirety.

### TECHNICAL FIELD

The present disclosure is generally related to computer systems, and is more specifically related to systems and methods for natural language processing.

### BACKGROUND

Interpreting unstructured information represented by a natural language text may be hindered by polysemy which is an intrinsic feature of natural languages. Identification, comparison and determining the degree of similarity of semantically similar language constructs may facilitate the task of interpreting natural language texts.

### SUMMARY OF THE DISCLOSURE

In accordance with one or more aspects of the present disclosure, an example method may comprise: receiving identifiers of a first plurality of word groups within a natural language text, each word group comprising one or more natural language words; associating an object represented by each word group with a concept of an ontology; identifying, within the natural language text, a second plurality of word groups, wherein each word group of the second plurality of word groups is associated with the concept of the ontology; responsive to receiving a confirmation that a word group of the second plurality of word groups represents an object associated with the concept of the ontology, modifying a parameter of a classification model that produces a value reflecting a degree of association of a given object with the concept of the ontology.

In accordance with one or more aspects of the present disclosure, an example system may comprise: a memory; and a processor, coupled to the memory, wherein the processor is configured to: receive identifiers of a first plurality of word groups within a natural language text, each word group comprising one or more natural language words; associate an object represented by each word group with a concept of an ontology; identify, within the natural language text, a second plurality of word groups, wherein each word group of the second plurality of word groups is associated with the concept of the ontology; responsive to receiving a confirmation that a word group of the second plurality of word groups represents an object associated with the concept of the ontology, modify a parameter of a classification model that produces a value reflecting a degree of association of a given object with the concept of the ontology.

In accordance with one or more aspects of the present disclosure, an example computer-readable non-transitory storage medium may comprise executable instructions that, when executed by a computing device, cause the computing device to: receive identifiers of a first plurality of word groups within a natural language text, each word group comprising one or more natural language words; associate an object represented by each word group with a concept of an ontology; identify, within the natural language text, a second plurality of word groups, wherein each word group of the second plurality of word groups is associated with the concept of the ontology; responsive to receiving a confirmation that a word group of the second plurality of word groups represents an object associated with the concept of the ontology, modify a parameter of a classification model that produces a value reflecting a degree of association of a given object with the concept of the ontology.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a flow diagram of one illustrative example of a method for searching and extracting entities based on analyzing natural language texts, in accordance with one or more aspects of the present disclosure.

FIG. 2A depicts example GUI screens for displaying natural language texts in which objects associated with certain ontology concepts are visually highlighted, in accordance with one or more aspects of the present disclosure.

FIG. 2B depicts example GUI screens for displaying natural language texts in which objects associated with certain ontology concepts are visually highlighted, in accordance with one or more aspects of the present disclosure.

FIG. 2C depicts example GUI screens for displaying natural language texts in which objects associated with certain ontology concepts are visually highlighted, in accordance with one or more aspects of the present disclosure.

FIG. 3A schematically illustrates example graphical user interface (GUI) for visually representing labeled text where entities related to different concepts of the ontology are highlighted with different colors.

FIG. 3B presents a fragment of a graph representing information (entities and relations) extracted from the text shown on FIGS. 2A-2C.

FIG. 4 depicts a flow diagram of one illustrative example of a method 400 for performing a semantico-syntactic analysis of a natural language sentence, in accordance with one or more aspects of the present disclosure.

FIG. 5 schematically illustrates an example of a lexico-morphological structure of a sentence, in accordance with one or more aspects of the present disclosure.

FIG. 6 schematically illustrates language descriptions representing a model of a natural language, in accordance with one or more aspects of the present disclosure.

FIG. 7 schematically illustrates examples of morphological descriptions, in accordance with one or more aspects of the present disclosure.

FIG. 8 schematically illustrates examples of syntactic descriptions, in accordance with one or more aspects of the present disclosure.

FIG. 9 schematically illustrates examples of semantic descriptions, in accordance with one or more aspects of the present disclosure.

FIG. 10 schematically illustrates examples of lexical descriptions, in accordance with one or more aspects of the present disclosure.

FIG. 11 schematically illustrates example data structures that may be employed by one or more methods implemented in accordance with one or more aspects of the present disclosure.

FIG. 12 schematically illustrates an example graph of generalized constituents, in accordance with one or more aspects of the present disclosure.

FIG. 13 illustrates an example syntactic structure corresponding to the sentence illustrated by FIG. 12.

FIG. 14 illustrates a semantic structure corresponding to the syntactic structure of FIG. 13.

FIG. 15 depicts a diagram of an example computing device implementing the methods described herein.

### DETAILED DESCRIPTION

Described herein are methods and systems for extracting entities for creating ontologies by analyzing natural language texts. The method is based on an assumption that entities related to the same class, concept of an ontology, may act identically in certain semantic contexts. So, to detect such entities in natural language texts is enough to train a computer device to find similar semantic contexts and to advance hypotheses.

“Ontology” herein shall refer to a model representing objects pertaining to a certain branch of knowledge (subject area) and relationships among such objects. An ontology may comprise definitions of a plurality of classes, such that each class corresponds to a concept of the subject area. Each class definition may comprise definitions of one or more objects associated with the class. Following the generally accepted terminology, an ontology class may also be referred to as concept, and an object belonging to a class may also be referred to as an instance of the concept.

Each class definition may further comprise one or more relationship definitions describing the types of relationships that may be associated with the objects of the class. Relationships define various types of interaction between the associated objects. In certain implementations, various relationships may be organized into an inclusive taxonomy, e.g., “being a father” and “being a mother” relationships may be included into a more generic “being a parent” relationship, which in turn may be included into a more generic “being a blood relative” relationship.

Each class definition may further comprise one or more restrictions defining certain properties of the objects of the class. In certain implementations, a class may be an ancestor or a descendant of another class.

An object definition may represent a real life material object (such as a person or a thing) or a certain notion associated with one or more real life objects (such as a number or a word). In an illustrative example, class “Person” may be associated with one or more objects corresponding to certain persons.

In certain implementations, an object may be associated with two or more classes. An ontology may be an ancestor or/and a descendant of another ontology, in which case concepts and properties of the ancestor ontology would also pertain to the descendant ontology.

In certain implementations, an ontology may be represented by one or more Resource Definition Framework (RDF) graphs. The Resource Definition Framework assigns a unique identifier to each informational object and stores the information regarding such an object in the form of SPO triples, where S stands for “subject” and contains the identifier of the object, P stands for “predicate” and identifies some property of the object, and O stands for “object” and stores the value of that property of the object. This value can be either a primitive data type (string, number, Boolean value) or an identifier of another object. An RDF graph may be viewed as a set of non-contradictory statements regarding the informational objects and their properties, and hence may be employed to represent the relationships between an ontology concept and associated instances. In various alternative implementations, ontologies may be represented by other means employing suitable data structures including graphs, linked lists, arrays, etc.

The present disclosure provides system and methods for identifying, by a computing device, multiple semantic structures representing similar or identical objects, facts, features, or phenomena, and for associating the identified entities with the corresponding classes and objects of an ontology that is associated with the natural language text.

In accordance with one or more aspects of the present disclosure, a computing device implementing the method may receive a natural language text (e.g., a document or a collection of documents) associated with a certain text corpus). The computing device may further receive identifiers, within the natural language text, of a plurality of groups of one or more words referencing example objects that are associated with a certain concept of an ontology. Such a concept may represent a certain person, an organization, an event, etc. In certain implementations, the identifiers of the groups of words may be received via a graphical user interface (GUI) allowing the user to visually highlight parts of the displayed text. Alternatively, the identifiers of the groups of words may be received as metadata accompanying the natural language text. In an illustrative example, the identifiers of the groups of words may be present within a certain section of the natural language text (e.g., within a certain subset of pages).

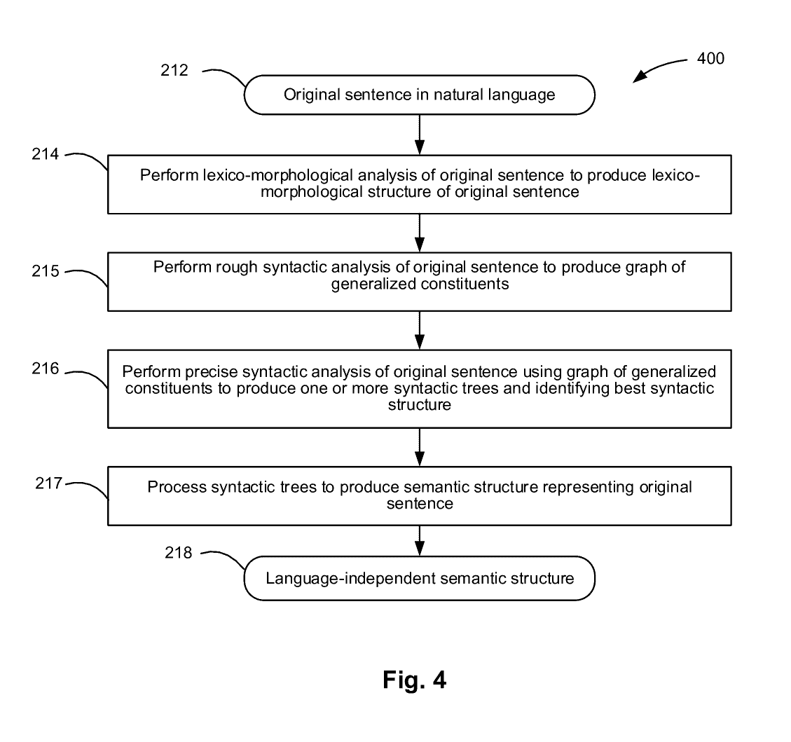

The computing device may then perform a semantico-syntactic analysis of the natural language text. The syntactic and sematic analysis may yield a plurality of semantic structures representing each natural language sentence. Each semantic structure may be represented by an acyclic graph that includes a plurality of nodes corresponding to semantic classes and a plurality of edges corresponding to semantic relationships between constituents of the sentence, as described in more details herein below with reference to FIG. 4. The computing device may identify, among a plurality of semantic structures produced by the semantico-syntactic analysis, one or more semantic structures that are similar, in view of a certain similarity metric, to at least one of semantic structures representing the sentences that include the highlighted words.

In certain implementations, the identification of similar semantic structures may be performed using a classification model that may, in turn, include a set of classification rules. A classification rule may comprise a set of logical expressions defined on one or more semantic structure templates. The logical expressions may reflect one or more semantic structure similarity factors, so that the classification rule set may determine whether or not two given semantic structure are similar in view of the chosen similarity metric.

The computing device may apply the classification model repeatedly to the plurality of semantic structures produced by the semantico-syntactic analysis of the natural language text in order to produce a graph representing plurality of entities related to diverse ontology concepts and the relationships between them.

In certain implementations, in estimating the degree of association of a given semantic structure with a certain ontology concept, the computing device may employ machine learning methods that utilize a pre-existing or dynamically created evidence data set that correlates the semantic structure parameters and ontology concepts. In an illustrative example, such an evidence data set may be created by prompting, via a GUI, the user to confirm that a word group corresponding to a semantic structure that was identified, by applying the classification model, as representing an object associated with a certain ontology concept, does in fact represent such an object that is associated with the identified ontology concept.

In an illustrative example, the processing device may utilize the evidence data set to construct or modify one or more classification rules that produce a value reflecting the degree of association of an object presented by selected group of words and belonging to a given semantic structure with a certain ontology concept. The computing device may evaluate the classification model for a plurality of concepts, and then associate the semantic structure with the concept corresponding to the optimal (e.g., minimal or maximal) similarity value.

The ontology produced by the systems and methods operating in accordance with one or more aspects of the present disclosure may be utilized for performing various natural language processing operations, such as machine translation, semantic search, object classification and clustering, etc.

Various aspects of the above referenced methods and systems are described in details herein below by way of examples, rather than by way of limitation.

“Computing device” herein shall refer to a data processing device having a general purpose processor, a memory, and at least one communication interface. Examples of computing devices that may employ the methods described herein include, without limitation, desktop computers, notebook computers, tablet computers, and smart phones.

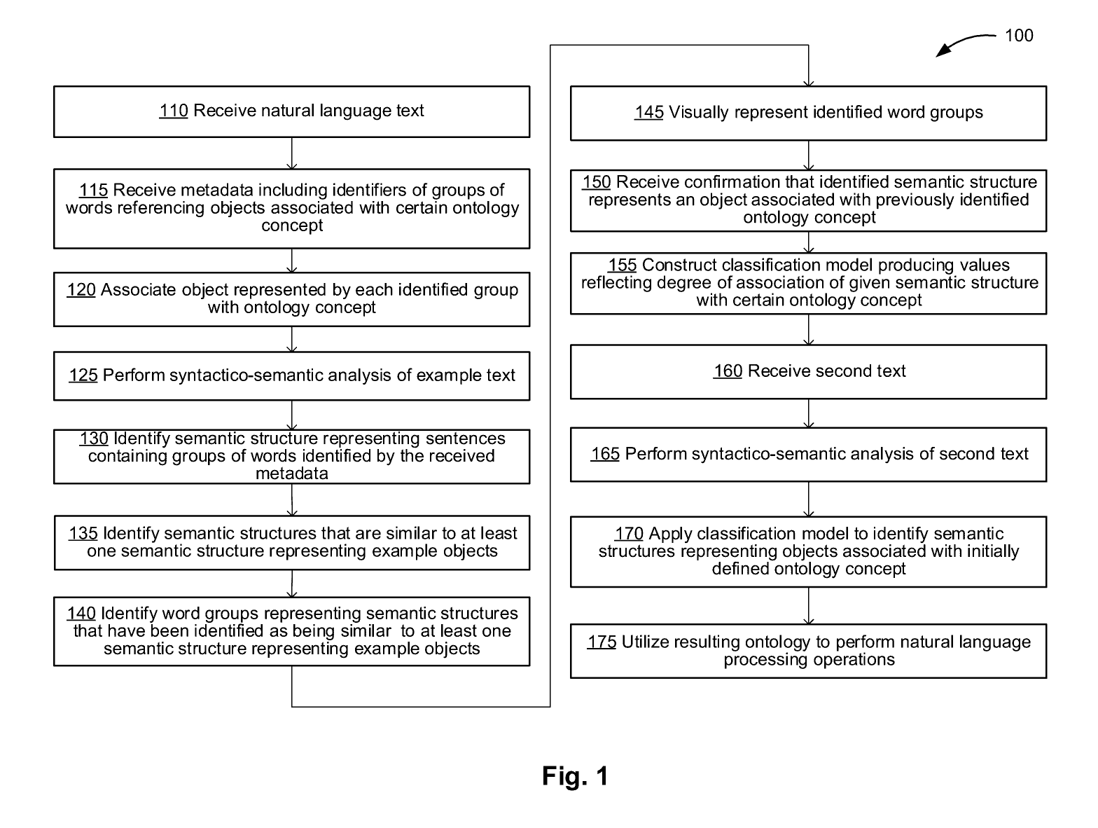

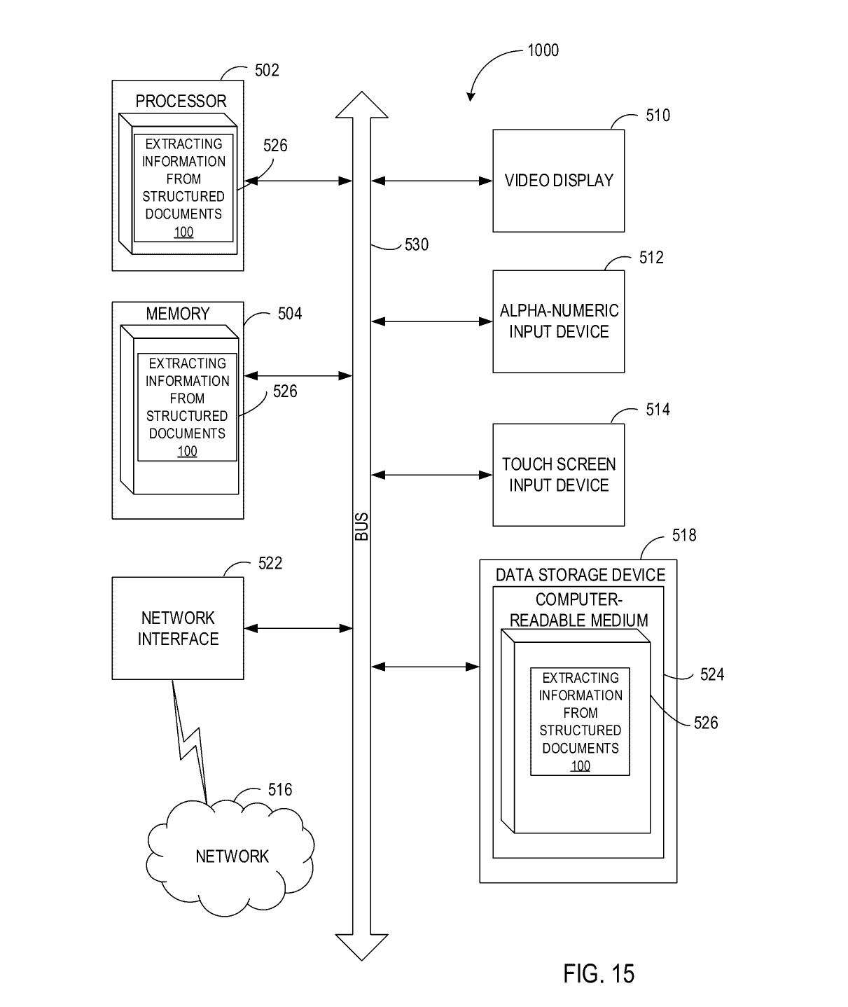

FIG. 1 depicts a flow diagram of an illustrative example of a method 100 for extracting entities by analyzing natural language texts, in accordance with one or more aspects of the present disclosure. Method 100 and/or each of its individual functions, routines, subroutines, or operations may be performed by one or more processors of the computing device (e.g., computing device 1000 of FIG. 15) implementing the method. In certain implementations, method 100 may be performed by a single processing thread. Alternatively, method 100 may be performed by two or more processing threads, each thread implementing one or more individual functions, routines, subroutines, or operations of the method. In an illustrative example, the processing threads implementing method 100 may be synchronized (e.g., using semaphores, critical sections, and/or other thread synchronization mechanisms). Alternatively, the processing threads implementing method 100 may be executed asynchronously with respect to each other.

At block 110, a computing device implementing the method may receive a natural language text (e.g., a document or a collection of documents) associated with a certain text corpus). In an illustrative example, the computing device may receive the natural language text in the form of an electronic document which may be produced by scanning or otherwise acquiring an image of a paper document and performing optical character recognition (OCR) to produce the document text associated with the documents. In an illustrative example, the computing device may receive the natural language text in the form of one or more formatted files, such as word processing files, electronic mail messages, digital content files, etc.

At block 115, the computing device may receive identifiers, within the natural language text, of one or more groups of words. Each group of words may include one or more words. A group of words may reference an example object associated with a certain concept of an ontology associated with the text corpus. Such a concept may represent a certain person, an organization, or an event, e.g., Steve Jobs, United Nations, or the Olympics. In certain implementations, the identifiers of the groups of words may be received via a graphical user interface (GUI). Such a GUI may include various controls for selecting an identifier of an ontology concept and for highlighting, within the natural language text being displayed within the GUI screen, one or more words representing example objects associated with the selected ontology concept. Alternatively, identifiers of one or more group of words that reference an object representing a certain ontology concept may be received as metadata accompanying the natural language text. In certain implementations, such metadata may be created by another natural language processing application. In an illustrative example, the identifiers of the example objects may be grouped within a certain section of the natural language text (e.g., within a certain subset of pages). Alternatively, the identifiers of the example objects may be regularly or randomly distributed throughout the whole text.

At block 120, the computing device may associate an object represented by each identified word group with an ontology concept. In an illustrative example, the ontology concept may be identified via a user interface that prompts the user to select an ontology concept corresponding to a highlighted group of words. Alternatively, the ontology concept may be identified by the metadata accompanying the natural language text.

At block 125, the computing device may perform a semantico-syntactic analysis of the natural language text. The syntactic and sematic analysis may yield a plurality of semantic structures representing each natural language sentence. Each semantic structure may be represented by an acyclic graph that includes a plurality of nodes corresponding to semantic classes and a plurality of edges corresponding to semantic relationships, as described in more details herein below with reference to FIG. 4. For simplicity, any subset of a semantic structure shall be referred herein as a “structure” (rather than a “substructure”), unless the parent-child relationship between two semantic structures is at issue.

At block 130, the computing device may identify, among the plurality of semantic structures produced by the semantico-syntactic analysis, semantic structures representing sentences that contain one or more word groups identified by the metadata referenced by block 115.

At block 135, the computing device may identify, among the plurality of semantic structure produced by operations described with reference to block 125, one or more semantic structures that are similar, in view of a certain similarity metric, to at least one of semantic structures representing sentences that contain one or more word groups identified by the received metadata.

Depending upon the requirements to the accuracy and/or computational complexity involved, the similarity metric may take into account various factors including: structural similarity of the semantic structures; presence of the same deep slots or slots associated with the same semantic class; presence of the same lexical or semantic classes associated with the nodes of the semantic structures, presence of ancestor-descendant relationship in certain nodes of the semantic structures, such that the ancestor and the descendant are divided by a certain number of semantic structure levels; presence of a common ancestor for certain semantic classes and the distance between the nodes representing those classes. If certain semantic classes are found equivalent or substantially similar, the metric may further take into account the presence or absence of certain differentiating semantemes and/or other factors.

In certain implementations, the identification of similar semantic structures may be performed using classification model that may, in turn, include a set of classification rules. A classification rule may comprise a set of logical expressions defined on one or more semantic structure templates. The logical expressions may reflect one or more of the above referenced similarity factors, so that the classification rule set may determine whether or not two given semantic structure are similar in view of the chosen similarity metric. In various illustrative examples, a classification rule may ascertain the structural similarity of the semantic structures; another classification rule may ascertain the presence of the same deep slots or slots associated with the same semantic class; another classification rule may ascertain the presence of the same lexical or semantic classes associated with the nodes of the semantic structures; another classification rule may ascertain the presence of ancestor-descendant relationship in certain nodes of the semantic structures, such that the ancestor and the descendant are divided by a certain number of semantic structure levels; another classification rule may ascertain the presence of a common ancestor for certain semantic classes and the distance between the nodes representing those classes; another classification rule may ascertain the presence of certain differentiating semantemes and/or other factors.

The computing device may apply the set of classification model to the plurality of semantic structures produced by the semantico-syntactic analysis of the natural language text in order to produce an annotated RDF graph representing the plurality of entities and relationships between them.

In certain implementations, in estimating the degree of association of a given semantic structure with a certain ontology concept, the computing device may employ automated classification methods (also known as “machine learning” methods) that utilize a pre-existing or dynamically created evidence data set that correlates the semantic structure parameters and ontology concepts. Such methods include differential evolution methods, genetic algorithms, naïve Bayes classifier, random forest methods, etc.

The computing device may create and/or update the evidence data set based on the feedback received with respect to the semantic structures that have been identified, at block 130, as being similar, in view of the chosen similarity metric, to at least one of the plurality of semantic structures representing sentences that contain one or more word groups identified by the received metadata.

In an illustrative example, such an evidence data set may be created or updated by prompting, via a GUI, the user to confirm that a semantic structure that has been identified, at block 130, as being similar to at least one of the plurality of semantic structures representing sentences that contain one or more word groups identified by the received metadata, is in fact similar to one or more of those semantic structures. In another illustrative example, the evidence data set may be further updated by prompting, via a GUI, the user to confirm that a given semantic structure that has been identified, by applying the classification model, as representing an object associated with a certain ontology concept, does in fact represent such an object that is associated with the identified ontology concept.

At block 140, the computing device may identify word groups representing the semantic structures that have been identified, at block 135, as being similar, in view of the chosen similarity metric, to at least one of the plurality of semantic structures representing sentences that contain one or more word groups identified by the received metadata.

At block 145, the computing device may display, via a GUI, the identified word groups. With respect to each displayed word group, the computing device may prompt the user to confirm the word group does in fact represent an object associated with the initially selected ontology concept.

Responsive to receiving, at block 150, such a confirmation with respect a particular semantic structure, the computing device may, at block 155, may update the evidence data set with the received confirmation, and may further utilize the updated evidence data set to construct or modify one or more parameters of classification rules of the classification model that produces a value reflecting the degree of association of a given semantic structure with a certain ontology concept. In an illustrative example, the computing device may modify one or more classification model parameters in view of the feedback received at block 150. After updating the parameters of classification model, the method 100 may be repeated on the same or another texts until the satisfactory result of the automatic extraction of entities will be achieved.

The computing device may then utilize the updated parameters of classification model set for processing other natural language texts. In an illustrative example, such a natural language text may be received by the computing device at block 160.

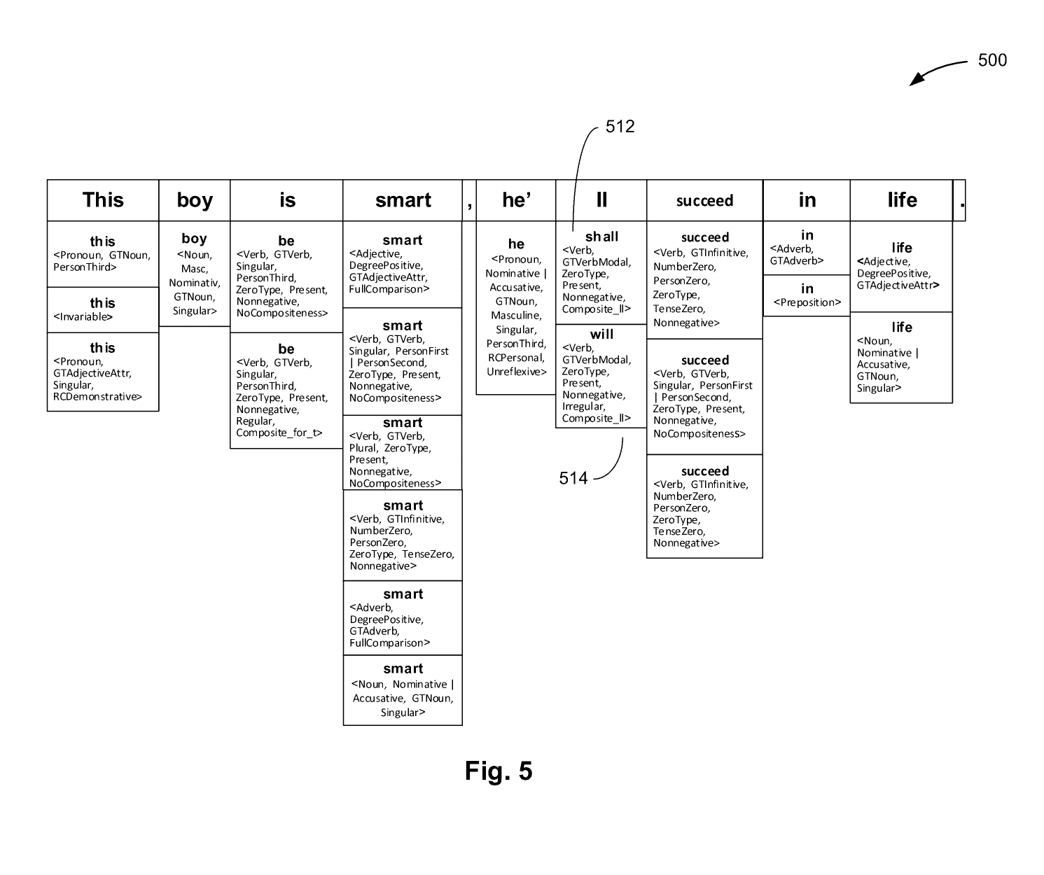

At block 165, the computing device may perform a semantico-syntactic analysis of the received natural language text. The syntactic and sematic analysis may yield a plurality of semantic structures representing each natural language sentence, as described in more details herein below with reference to FIG. 5.

At block 170, the computing device may apply the classification model to the plurality of semantic structures produced by the semantico-syntactic analysis, in order to identify semantic structures that represent objects associated with the initially defined ontology concept. In an illustrative example, the computing device may apply one or more classification rules for a plurality of concepts, and then associate the semantic structure with the concept corresponding to the optimal (e.g., minimal or maximal) similarity value produced by the classification rules.

The operations of method 100 described herein above with references to block 115-170 may, if desired, be repeated for other ontology concepts or initially diverse tools may be used for selecting objects of different concepts. For example, a user may use different colors for highlighting word groups associated with objects of different concepts.

At block 175, the resulting ontology may be utilized for performing various natural language processing operations, such as machine translation, semantic search, object classification and clustering, etc.

In certain implementations, method 100 may be applied to a collection of structured documents of a certain type. Such documents may have a similar structure, and may in various illustrative examples be represented by contracts, certificates, applications, etc. For example, the same fields or columns may contain names of persons, others fields or columns may contain titles of departments or companies, the thirds—dates, etc. Thus, the semantico-syntactic analysis of the natural language text described herein above with reference to block 120 of FIG. 1 may be preceded by one or more document pre-processing operations that are performed in order to determine the document structure. In an illustrative example, the document structure may include a multi-level hierarchical structure, in which document sections are delimited by headings and sub-headings. In another illustrative example, the document structure may include one or more tables containing multiple rows and columns, at least some of which may be associated with headers, which in turn may be organized in a multi-level hierarchy. In another illustrative example, the document structure may include certain text fields associated with pre-defined information types, such as a signature field, a date field, an address field, a name field, etc. The computing device implementing method 100 may interpret the document structure to derive certain document structure information that may be utilized to enhance the textual information comprised by the document. In certain implementations, in analyzing structured documents, the computing device may employ various auxiliary ontologies comprising classes and concepts reflecting a specific document structure. Auxiliary ontology classes may be associated with certain production rules that may be applied to the plurality of semantic structures produced by the syntactico-semantic analysis of the corresponding document.

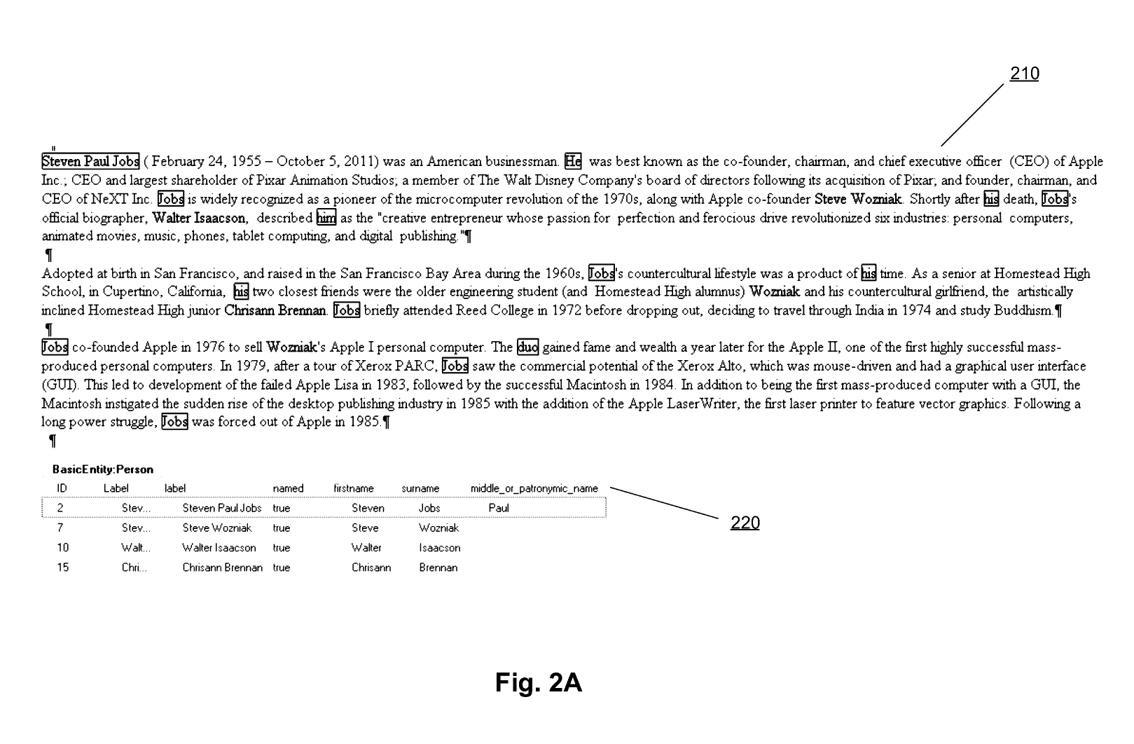

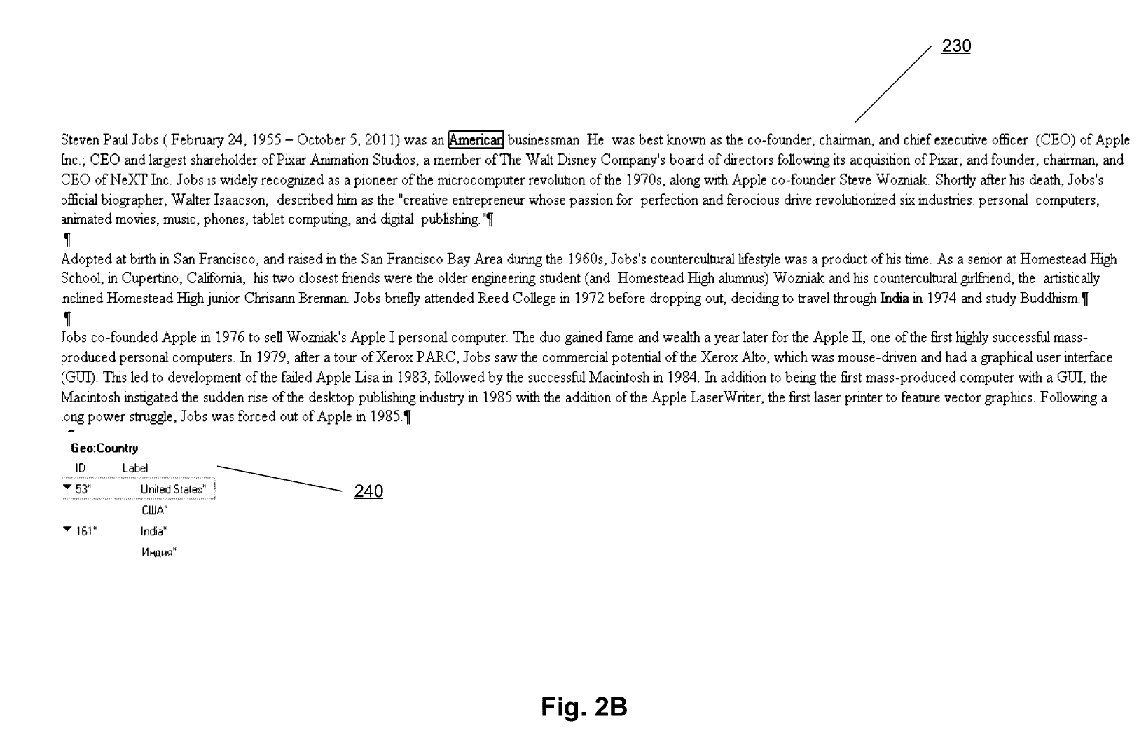

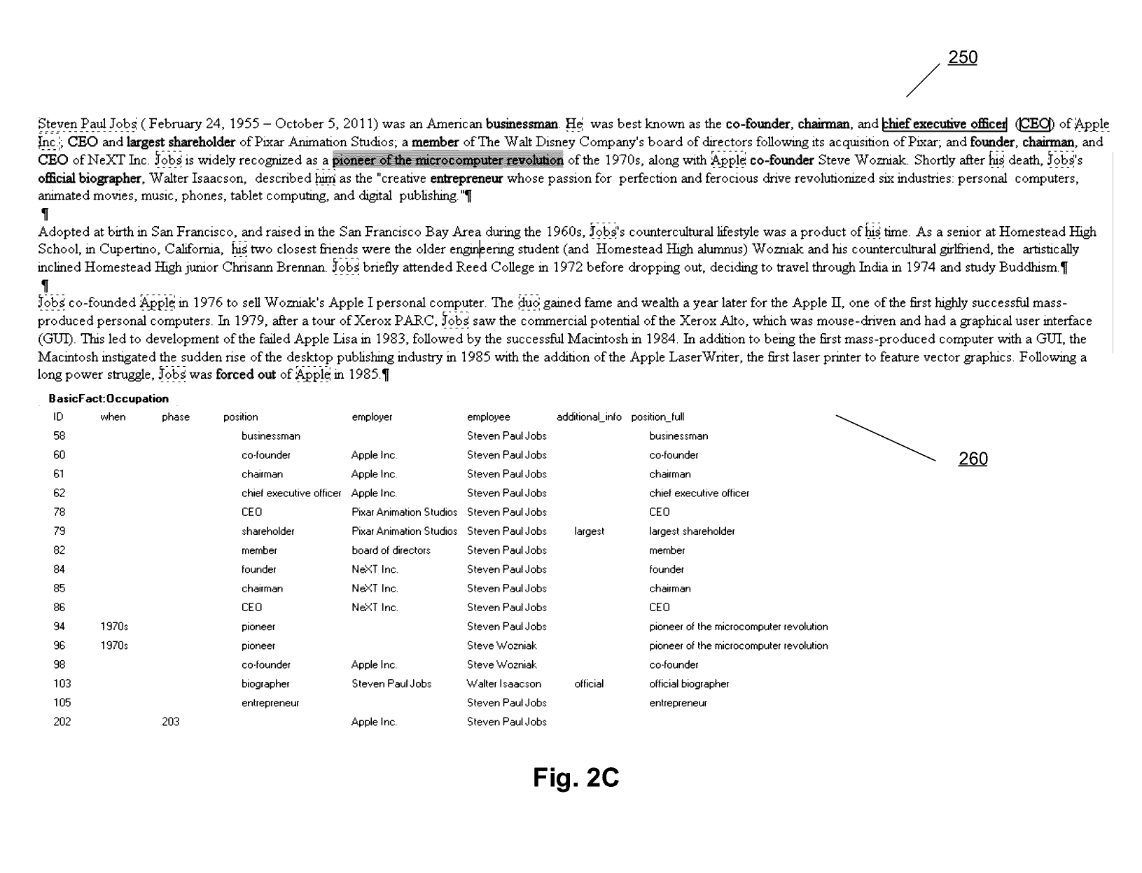

As noted herein above, the computing device implementing method 100 may present one or more GUI screens that include various controls for selecting an identifier of an ontology concept and for highlighting, within the natural language text being displayed within the GUI screen, one or more words or word groups representing example objects associated with the selected ontology concept. FIGS. 2A-2C depict example GUI screens for displaying natural language texts in which objects associated with certain ontology concepts are visually highlighted.

FIG. 2A depicts an example GUI screen displaying a natural language text in which the objects associated with the concept “Person” are highlighted. The GUI implemented by the processing device may comprise the text window 210, in which the user may highlight the words and word combinations representing example objects associated with the selected ontology concept (“Person”). The GUI may further comprise a table 220 representing at least a portion of the ontology that is associated with the selected ontology concept. As schematically illustrated by FIG. 2A, the ontology may store values of several attributes for each object of the class “Person,” including “firstname,” “middlename,” and “surname” attributes.

FIG. 2B depicts an example GUI screen displaying a natural language text in which the objects associated with the concept “Country” are highlighted. The GUI implemented by the processing device may comprise the text window 230, in which the user may highlight the words and word combinations representing example objects associated with the selected ontology concept (“Country”). The GUI may further comprise a table 240 representing at least a portion of the ontology that is associated with the selected ontology concept. As schematically illustrated by FIG. 2B, the ontology may store one or more values of the attribute “label” for each object of the class “Country.”

FIG. 2C depicts an example GUI screen displaying a natural language text in which the objects associated with the concept “Occupation” are highlighted. The GUI implemented by the processing device may comprise the text window 250, in which the user may highlight the words and word combinations representing example objects associated with the selected ontology concept (“Occupation”). The GUI may further comprise a table 260 representing at least a portion of the ontology that is associated with the selected ontology concept. As schematically illustrated by FIG. 2C, the ontology reflects the “employer-employee” relationship and also specifies an attribute “position” associated with an object of class “employee.”

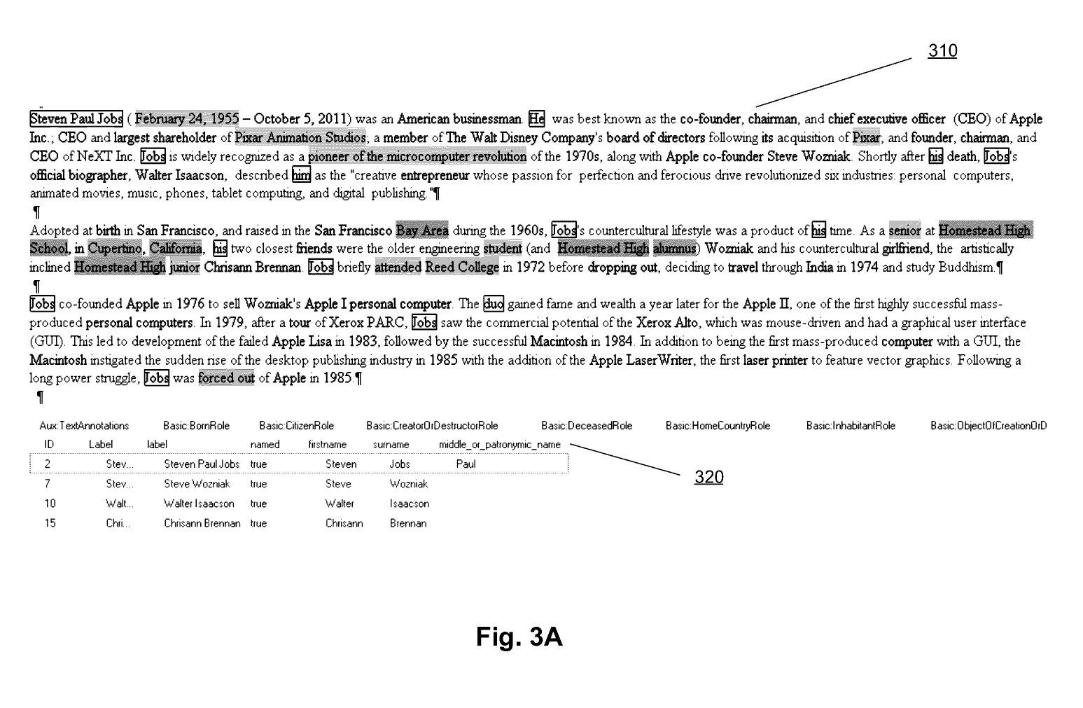

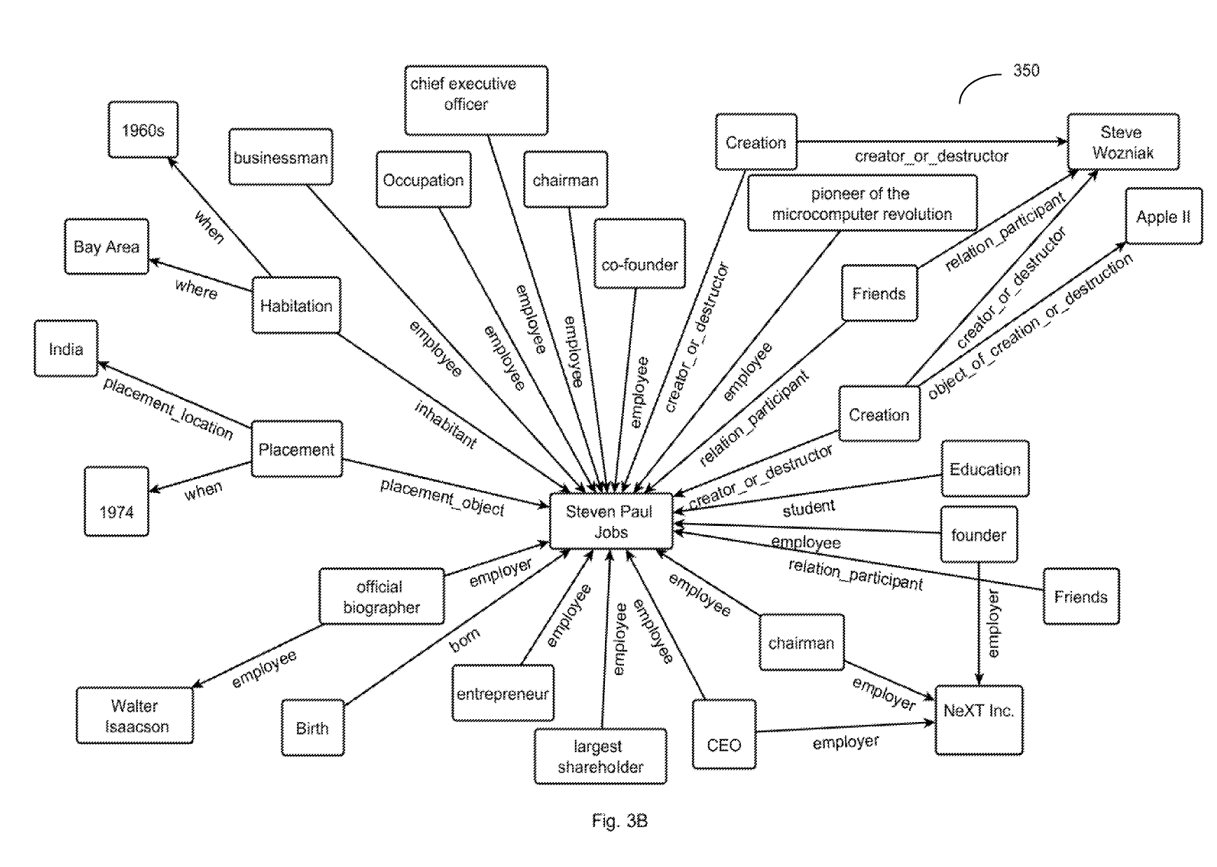

The computing device implementing method 100 may implement a GUI for visually representing the ontology that has been produced by analyzing natural language texts in accordance with one or more aspects of the present disclosure, as schematically illustrated by FIGS. 3A-3B. FIG. 3A depicts a GUI screen including a text window 310, in which words and/or word combinations may be highlighted that represent various objects that have been identified by the processing device and being associated with certain ontology concepts. The GUI screen may further comprise a table 320 representing at least a portion of the ontology that is associated with the selected ontology concepts. FIG. 3B depicts a GUI screen displaying at least a portion of graph 350 that includes a plurality of nodes corresponding to ontology objects and a plurality of edges corresponding to semantic relationships between the nodes.

FIG. 4 depicts a flow diagram of one illustrative example of a method 400 for performing a semantico-syntactic analysis of a natural language sentence 412, in accordance with one or more aspects of the present disclosure. Method 400 may be applied to one or more syntactic units (e.g., sentences) comprised by a certain text corpus, in order to produce a plurality of semantico-syntactic trees corresponding to the syntactic units. In various illustrative examples, the natural language sentences to be processed by method 400 may be retrieved from one or more electronic documents which may be produced by scanning or otherwise acquiring images of paper documents and performing optical character recognition (OCR) to produce the texts associated with the documents. The natural language sentences may be also retrieved from various other sources including electronic mail messages, social networks, digital content files processed by speech recognition methods, etc.

At block 214, the computing device implementing the method may perform lexico-morphological analysis of sentence 212 to identify morphological meanings of the words comprised by the sentence. “Morphological meaning” of a word herein shall refer to one or more lemma (i.e., canonical or dictionary forms) corresponding to the word and a corresponding set of values of grammatical attributes defining the grammatical value of the word. Such grammatical attributes may include the lexical category of the word and one or more morphological attributes (e.g., grammatical case, gender, number, conjugation type, etc.). Due to homonymy and/or coinciding grammatical forms corresponding to different lexico-morphological meanings of a certain word, two or more morphological meanings may be identified for a given word. An illustrative example of performing lexico-morphological analysis of a sentence is described in more details herein below with references to FIG. 5.

At block 215, the computing device may perform a rough syntactic analysis of sentence 212. The rough syntactic analysis may include identification of one or more syntactic models which may be associated with sentence 212 followed by identification of the surface (i.e., syntactic) associations within sentence 212, in order to produce a graph of generalized constituents. “Constituent” herein shall refer to a contiguous group of words of the original sentence, which behaves as a single grammatical entity. A constituent comprises a core represented by one or more words, and may further comprise one or more child constituents at lower levels. A child constituent is a dependent constituent and may be associated with one or more parent constituents.

At block 216, the computing device may perform a precise syntactic analysis of sentence 212, to produce one or more syntactic trees of the sentence. The pluralism of possible syntactic trees corresponding to a given original sentence may stem from homonymy and/or coinciding grammatical forms corresponding to different lexico-morphological meanings of one or more words within the original sentence. Among the multiple syntactic trees, one or more best syntactic tree corresponding to sentence 212 may be selected, based on a certain rating function talking into account compatibility of lexical meanings of the original sentence words, surface relationships, deep relationships, etc.

At block 217, the computing device may process the syntactic trees to the produce a semantic structure 218 corresponding to sentence 212. Semantic structure 218 may comprise a plurality of nodes corresponding to semantic classes, and may further comprise a plurality of edges corresponding to semantic relationships, as described in more details herein below.

FIG. 5 schematically illustrates an example of a lexico-morphological structure of a sentence, in accordance with one or more aspects of the present disclosure. Example lexical-morphological structure 500 may comprise having a plurality of “lexical meaning-grammatical value” pairs for an example sentence. In an illustrative example, “ll” may be associated with lexical meaning “shall” 512 and “will” 514. The grammatical value associated with lexical meaning 512 is <Verb, GTVerbModal, ZeroType, Present, Nonnegative, Composite II>. The grammatical value associated with lexical meaning 514 is <Verb, GTVerbModal, ZeroType, Present, Nonnegative, Irregular, Composite II>.

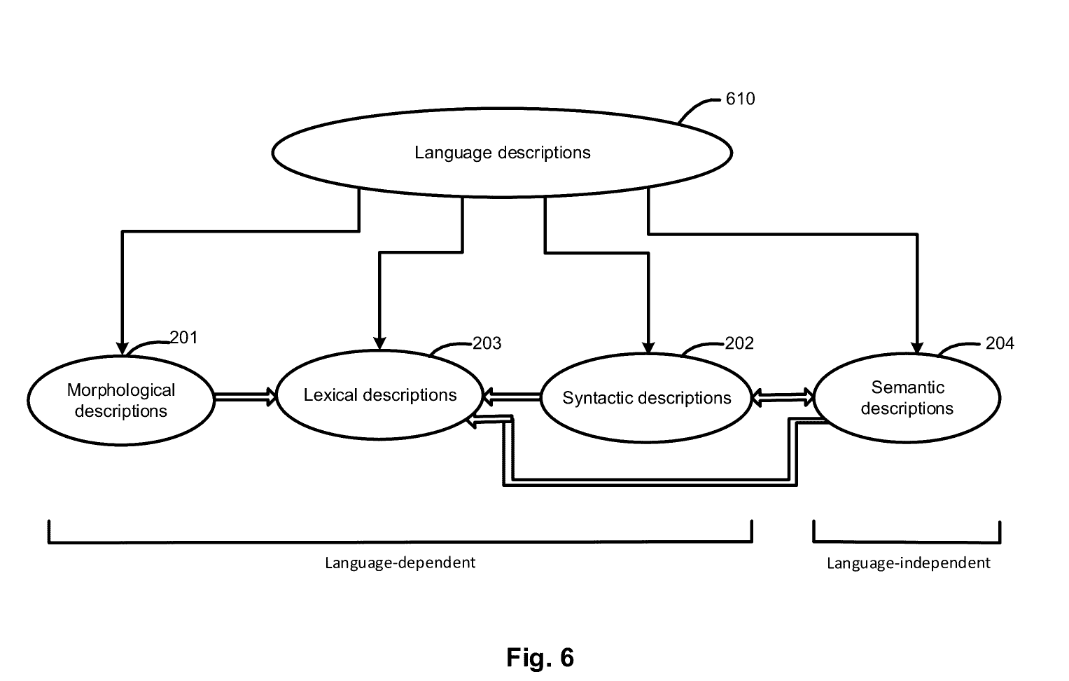

FIG. 6 schematically illustrates language descriptions 610 including morphological descriptions 101, lexical descriptions 103, syntactic descriptions 102, and semantic descriptions 104, and their relationship thereof. Among them, morphological descriptions 101, lexical descriptions 103, and syntactic descriptions 102 are language-specific. A set of language descriptions 610 represent a model of a certain natural language.

In an illustrative example, a certain lexical meaning of lexical descriptions 203 may be associated with one or more surface models of syntactic descriptions 202 corresponding to this lexical meaning. A certain surface model of syntactic descriptions 202 may be associated with a deep model of semantic descriptions 204.

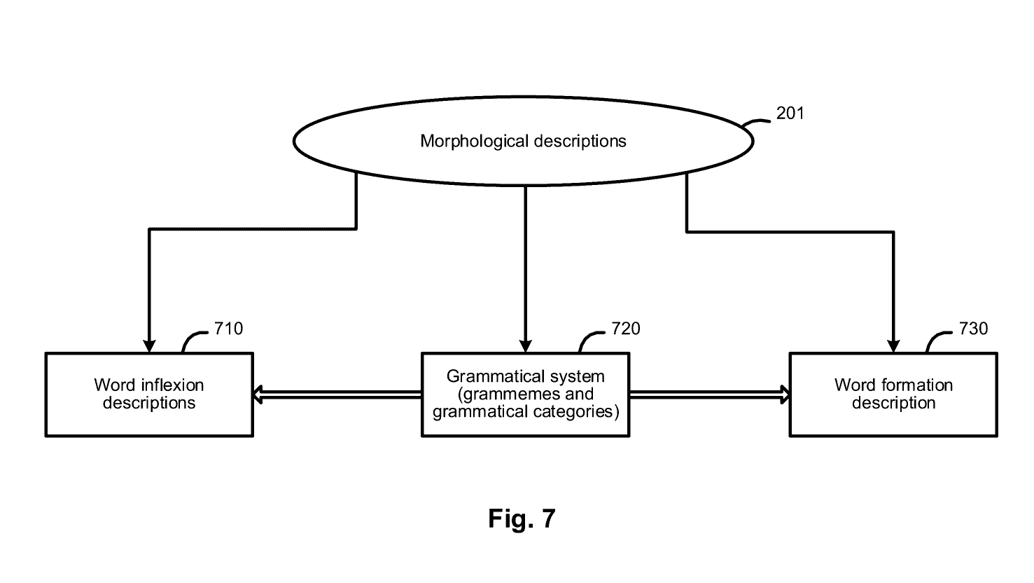

FIG. 7 schematically illustrates several examples of morphological descriptions. Components of the morphological descriptions 201 may include: word inflexion descriptions 710, grammatical system 720, and word formation description 730, among others. Grammatical system 720 comprises a set of grammatical categories, such as, part of speech, grammatical case, grammatical gender, grammatical number, grammatical person, grammatical reflexivity, grammatical tense, grammatical aspect, and their values (also referred to as “grammemes”), including, for example, adjective, noun, or verb; nominative, accusative, or genitive case; feminine, masculine, or neutral gender; etc. The respective grammemes may be utilized to produce word inflexion description 710 and the word formation description 730.

Word inflexion descriptions 710 describe the forms of a given word depending upon its grammatical categories (e.g., grammatical case, grammatical gender, grammatical number, grammatical tense, etc.), and broadly includes or describes various possible forms of the word. Word formation description 730 describes which new words may be constructed based on a given word (e.g., compound words).

According to one aspect of the present disclosure, syntactic relationships among the elements of the original sentence may be established using a constituent model. A constituent may comprise a group of neighboring words in a sentence that behaves as a single entity. A constituent has a word at its core and may comprise child constituents at lower levels. A child constituent is a dependent constituent and may be associated with other constituents (such as parent constituents) for building the syntactic descriptions 202 of the original sentence.

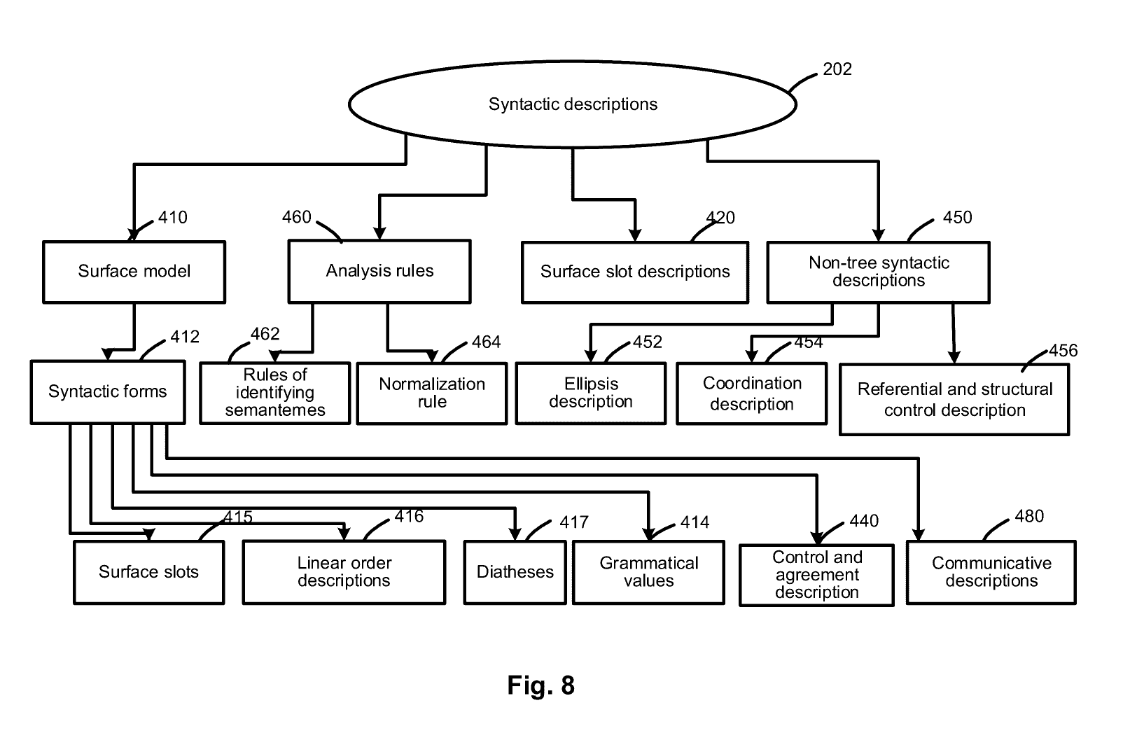

FIG. 8 illustrates exemplary syntactic descriptions. The components of the syntactic descriptions 202 may include, but are not limited to, surface models 410, surface slot descriptions 420, referential and structural control description 456, control and agreement description 440, non-tree syntactic description 450, and analysis rules 460. Syntactic descriptions 102 may be used to construct possible syntactic structures of the original sentence in a given natural language, taking into account free linear word order, non-tree syntactic phenomena (e.g., coordination, ellipsis, etc.), referential relationships, and other considerations.

Surface models 410 may be represented as aggregates of one or more syntactic forms (“syntforms” 412) employed to describe possible syntactic structures of the sentences that are comprised by syntactic description 102. In general, the lexical meaning of a natural language word may be linked to surface (syntactic) models 410. A surface model may represent constituents which are viable when the lexical meaning functions as the “core.” A surface model may include a set of surface slots of the child elements, a description of the linear order, and/or diatheses. “Diathesis” herein shall refer to a certain relationship between an actor (subject) and one or more objects, having their syntactic roles defined by morphological and/or syntactic means. In an illustrative example, a diathesis may be represented by a voice of a verb: when the subject is the agent of the action, the verb is in the active voice, and when the subject is the target of the action, the verb is in the passive voice.

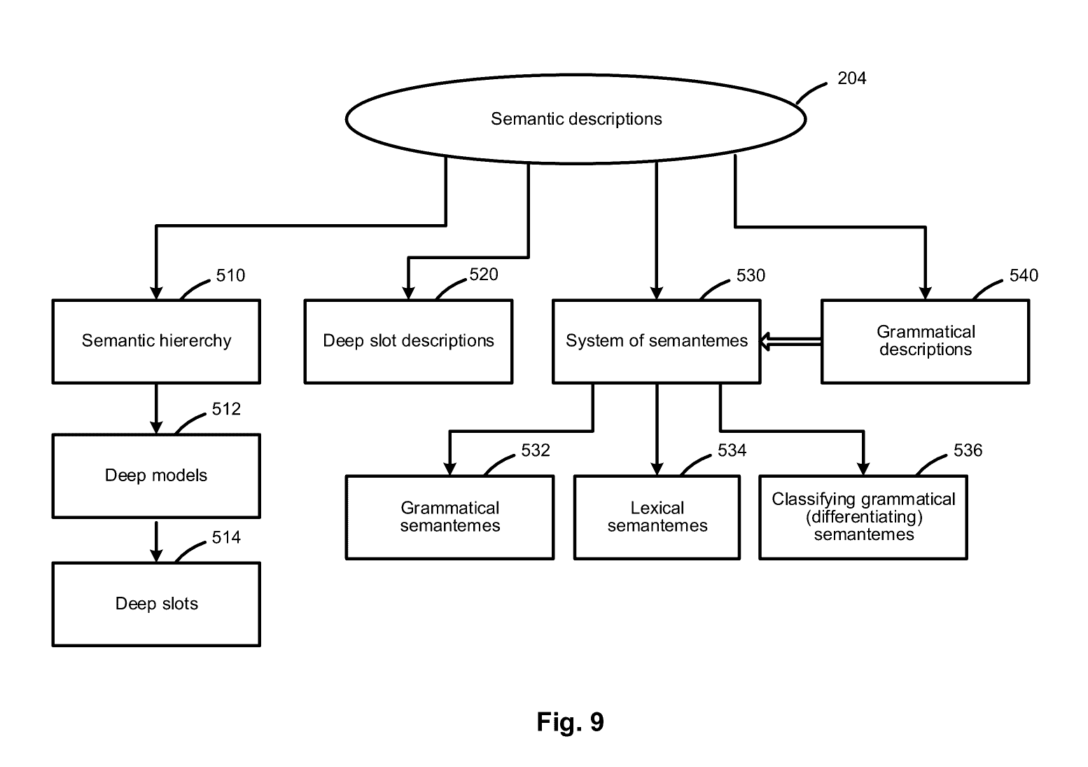

A constituent model may utilize a plurality of surface slots 415 of the child constituents and their linear order descriptions 416 to describe grammatical values 414 of possible fillers of these surface slots. Diatheses 417 may represent relationships between surface slots 415 and deep slots 514 (as shown in FIG. 9). Communicative descriptions 480 describe communicative order in a sentence.

Linear order description 416 may be represented by linear order expressions reflecting the sequence in which various surface slots 415 may appear in the sentence. The linear order expressions may include names of variables, names of surface slots, parenthesis, grammemes, ratings, the “or” operator, etc. In an illustrative example, a linear order description of a simple sentence of “Boys play football” may be represented as “Subject Core Object_Direct,” where Subject, Core, and Object_Direct are the names of surface slots 415 corresponding to the word order.

Communicative descriptions 480 may describe a word order in a syntform 412 from the point of view of communicative acts that are represented as communicative order expressions, which are similar to linear order expressions. The control and concord description 440 may comprise rules and restrictions which are associated with grammatical values of the related constituents and may be used in performing syntactic analysis.

Non-tree syntax descriptions 450 may be created to reflect various linguistic phenomena, such as ellipsis and coordination, and may be used in syntactic structures transformations which are generated at various stages of the analysis according to one or more aspects of the present disclosure. Non-tree syntax descriptions 450 may include ellipsis description 452, coordination description 454, as well as referential and structural control description 430, among others.

Analysis rules 460 may generally describe properties of a specific language and may be used in performing the semantic analysis. Analysis rules 460 may comprise rules of identifying semantemes 462 and normalization rules 464. Normalization rules 464 may be used for describing language-dependent transformations of semantic structures.

FIG. 9 illustrates exemplary semantic descriptions. Components of semantic descriptions 204 are language-independent and may include, but are not limited to, a semantic hierarchy 510, deep slots descriptions 520, a set of semantemes 530, and pragmatic descriptions 540.

The core of the semantic descriptions may be represented by semantic hierarchy 510 which may comprise semantic notions (semantic entities) which are also referred to as semantic classes. The latter may be arranged into hierarchical structure reflecting parent-child relationships. In general, a child semantic class may inherits one or more properties of its direct parent and other ancestor semantic classes. In an illustrative example, semantic class SUBSTANCE is a child of semantic class ENTITY and the parent of semantic classes GAS, LIQUID, METAL, WOOD_MATERIAL, etc.

Each semantic class in semantic hierarchy 510 may be associated with a corresponding deep model 512. Deep model 512 of a semantic class may comprise a plurality of deep slots 514 which may reflect semantic roles of child constituents in various sentences that include objects of the semantic class as the core of the parent constituent. Deep model 512 may further comprise possible semantic classes acting as fillers of the deep slots. Deep slots 514 may express semantic relationships, including, for example, “agent,” “addressee,” “instrument,” “quantity,” etc. A child semantic class may inherit and further expand the deep model of its direct parent semantic class.

Deep slots descriptions 520 reflect semantic roles of child constituents in deep models 512 and may be used to describe general properties of deep slots 514. Deep slots descriptions 520 may also comprise grammatical and semantic restrictions associated with the fillers of deep slots 514. Properties and restrictions associated with deep slots 514 and their possible fillers in various languages may be substantially similar and often identical. Thus, deep slots 514 are language-independent.

System of semantemes 530 may represents a plurality of semantic categories and semantemes which represent meanings of the semantic categories. In an illustrative example, a semantic category “DegreeOfComparison” may be used to describe the degree of comparison and may comprise the following semantemes: “Positive,” “ComparativeHigherDegree,” and “SuperlativeHighestDegree,” among others. In another illustrative example, a semantic category “RelationToReferencePoint” may be used to describe an order (spatial or temporal in a broad sense of the words being analyzed), such as before or after a reference point, and may comprise the semantemes “Previous” and “Subsequent.”. In yet another illustrative example, a semantic category “EvaluationObjective” can be used to describe an objective assessment, such as “Bad,” “Good,” etc.

System of semantemes 530 may include language-independent semantic attributes which may express not only semantic properties but also stylistic, pragmatic and communicative properties. Certain semantemes may be used to express an atomic meaning which corresponds to a regular grammatical and/or lexical expression in a natural language. By their intended purpose and usage, sets of semantemes may be categorized, e.g., as grammatical semantemes 532, lexical semantemes 534, and classifying grammatical (differentiating) semantemes 536.

Grammatical semantemes 532 may be used to describe grammatical properties of the constituents when transforming a syntactic tree into a semantic structure. Lexical semantemes 534 may describe specific properties of objects (e.g., “being flat” or “being liquid”) and may be used in deep slot descriptions 520 as restriction associated with the deep slot fillers (e.g., for the verbs “face (with)” and “flood,” respectively). Classifying grammatical (differentiating) semantemes 536 may express the differentiating properties of objects within a single semantic class. In an illustrative example, in the semantic class of HAIRDRESSER, the semanteme of <<RelatedToMen>> is associated with the lexical meaning of “barber,” to differentiate from other lexical meanings which also belong to this class, such as “hairdresser,” “hairstylist,” etc. Using these language-independent semantic properties that may be expressed by elements of semantic description, including semantic classes, deep slots, and semantemes, may be employed for extracting the semantic information, in accordance with one or more aspects of the present invention.

Pragmatic descriptions 540 allow associating a certain theme, style or genre to texts and objects of semantic hierarchy 510 (e.g., “Economic Policy,” “Foreign Policy,” “Justice,” “Legislation,” “Trade,” “Finance,” etc.). Pragmatic properties may also be expressed by semantemes. In an illustrative example, the pragmatic context may be taken into consideration during the semantic analysis phase.

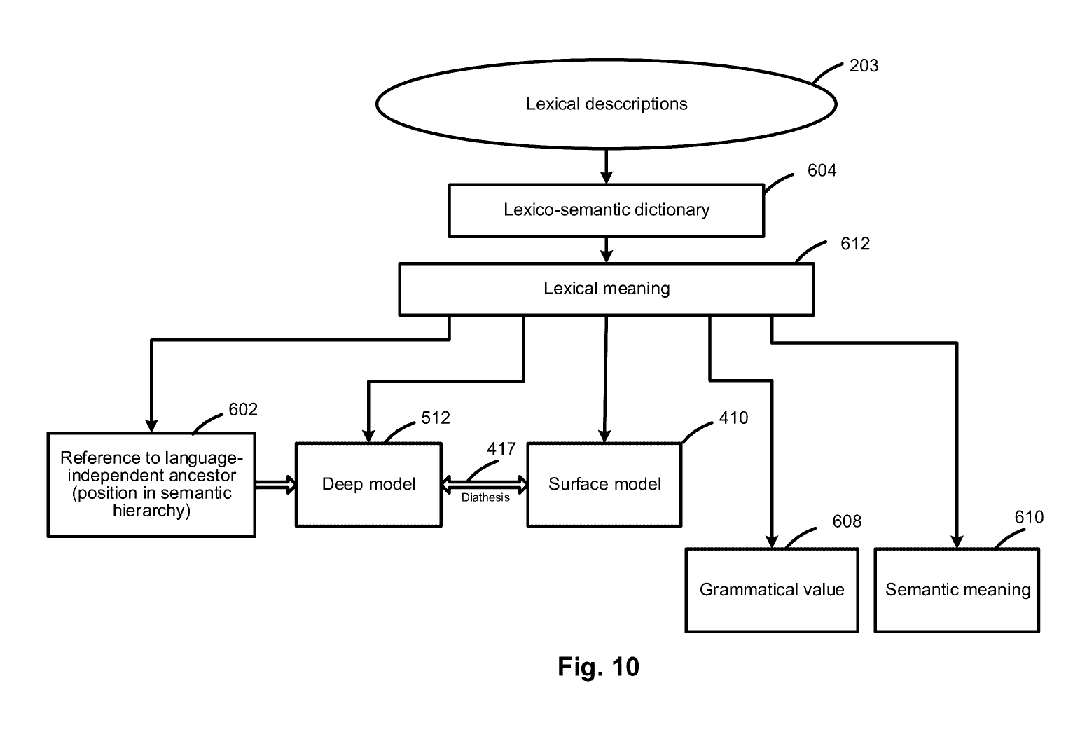

FIG. 10 illustrates exemplary lexical descriptions. Lexical descriptions 203 represent a plurality of lexical meanings 612, in a certain natural language, for each component of a sentence. For a lexical meaning 612, a relationship 602 to its language-independent semantic parent may be established to indicate the location of a given lexical meaning in semantic hierarchy 510.

A lexical meaning 612 of lexical-semantic hierarchy 510 may be associated with a surface model 410 which, in turn, may be associated, by one or more diatheses 417, with a corresponding deep model 512. A lexical meaning 612 may inherit the semantic class of its parent, and may further specify its deep model 152.

A surface model 410 of a lexical meaning may comprise includes one or more syntforms 412. A syntform, 412 of a surface model 410 may comprise one or more surface slots 415, including their respective linear order descriptions 416, one or more grammatical values 414 expressed as a set of grammatical categories (grammemes), one or more semantic restrictions associated with surface slot fillers, and one or more of the diatheses 417. Semantic restrictions associated with a certain surface slot filler may be represented by one or more semantic classes, whose objects can fill the surface slot.

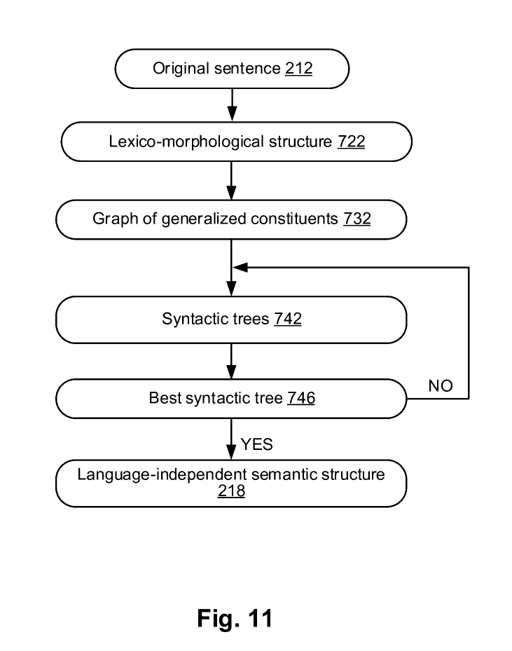

FIG. 11 schematically illustrates example data structures that may be employed by one or more methods described herein. Referring again to FIG. 4, at block 214, the computing device implementing the method may perform lexico-morphological analysis of sentence 212 to produce a lexico-morphological structure 722 of FIG. 11. Lexico-morphological structure 722 may comprise a plurality of mapping of a lexical meaning to a grammatical value for each lexical unit (e.g., word) of the original sentence. FIG. 5 schematically illustrates an example of a lexico-morphological structure.

At block 215, the computing device may perform a rough syntactic analysis of original sentence 212, in order to produce a graph of generalized constituents 732 of FIG. 11. Rough syntactic analysis involves applying one or more possible syntactic models of possible lexical meanings to each element of a plurality of elements of the lexico-morphological structure 722, in order to identify a plurality of potential syntactic relationships within original sentence 212, which are represented by graph of generalized constituents 732.

Graph of generalized constituents 732 may be represented by an acyclic graph comprising a plurality of nodes corresponding to the generalized constituents of original sentence 212, and further comprising a plurality of edges corresponding to the surface (syntactic) slots, which may express various types of relationship among the generalized lexical meanings. The method may apply a plurality of potentially viable syntactic models for each element of a plurality of elements of the lexico-morphological structure of original sentence 212 in order to produce a set of core constituents of original sentence 212. Then, the method may consider a plurality of viable syntactic models and syntactic structures of original sentence 212 in order to produce graph of generalized constituents 732 based on a set of constituents. Graph of generalized constituents 732 at the level of the surface model may reflect a plurality of viable relationships among the words of original sentence 212. As the number of viable syntactic structures may be relatively large, graph of generalized constituents 732 may generally comprise redundant information, including relatively large numbers of lexical meaning for certain nodes and/or surface slots for certain edges of the graph.

Graph of generalized constituents 732 may be initially built as a tree, starting with the terminal nodes (leaves) and moving towards the root, by adding child components to fill surface slots 415 of a plurality of parent constituents in order to reflect all lexical units of original sentence 212.

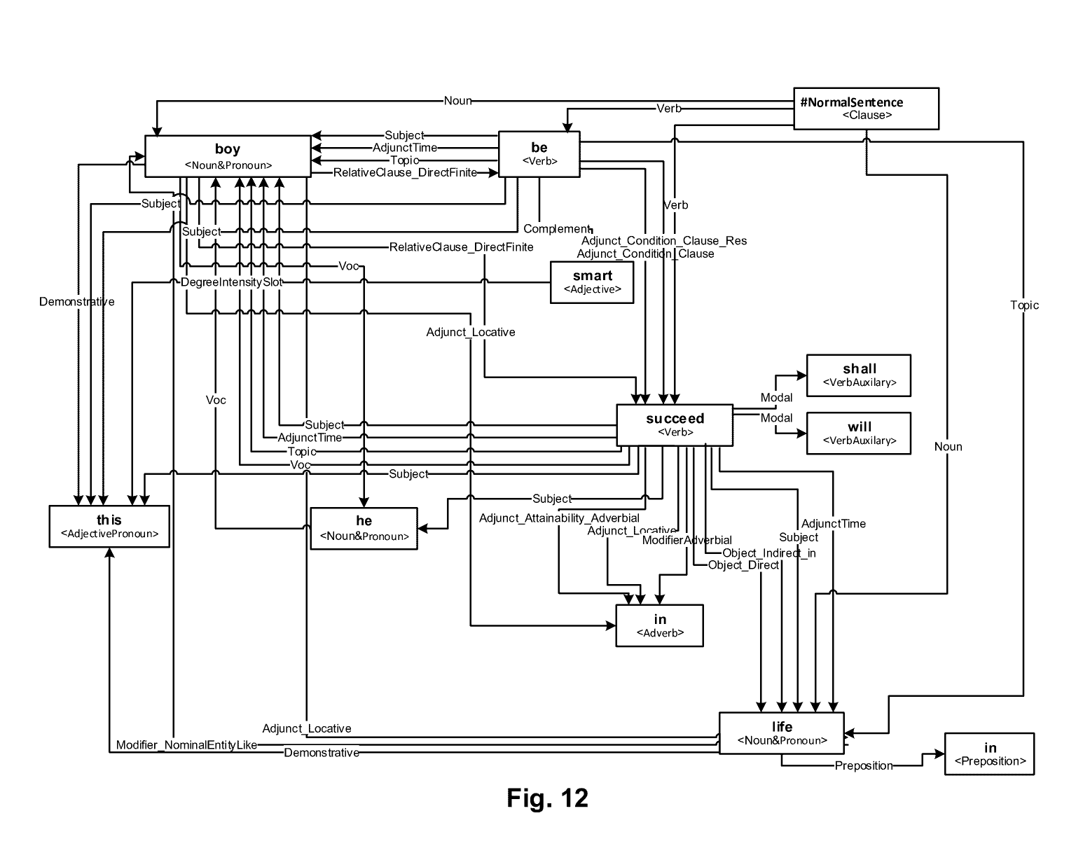

In certain implementations, the root of graph of generalized constituents 732 represents a predicate. In the course of the above described process, the tree may become a graph, as certain constituents of a lower level may be included into one or more constituents of an upper level. A plurality of constituents that represent certain elements of the lexico-morphological structure may then be generalized to produce generalized constituents. The constituents may be generalized based on their lexical meanings or grammatical values 414, e.g., based on part of speech designations and their relationships. FIG. 12 schematically illustrates an example graph of generalized constituents.

At block 216, the computing device may perform a precise syntactic analysis of sentence 212, to produce one or more syntactic trees 742 of FIG. 11 based on graph of generalized constituents 732. For each of one or more syntactic trees, the computing device may determine a general rating based on certain calculations and a priori estimates. The tree having the optimal rating may be selected for producing the best syntactic structure 746 of original sentence 212.

In the course of producing the syntactic structure 746 based on the selected syntactic tree, the computing device may establish one or more non-tree links (e.g., by producing redundant path among at least two nodes of the graph). If that process fails, the computing device may select a syntactic tree having a suboptimal rating closest to the optimal rating, and may attempt to establish one or more non-tree relationships within that tree. Finally, the precise syntactic analysis produces a syntactic structure 746 which represents the best syntactic structure corresponding to original sentence 212. In fact, selecting the best syntactic structure 746 also produces the best lexical values 240 of original sentence 212.

At block 217, the computing device may process the syntactic trees to the produce a semantic structure 218 corresponding to sentence 212. Semantic structure 218 may reflect, in language-independent terms, the semantics conveyed by original sentence. Semantic structure 218 may be represented by an acyclic graph (e.g., a tree complemented by at least one non-tree link, such as an edge producing a redundant path among at least two nodes of the graph). The original natural language words are represented by the nodes corresponding to language-independent semantic classes of semantic hierarchy 510. The edges of the graph represent deep (semantic) relationships between the nodes. Semantic structure 218 may be produced based on analysis rules 460, and may involve associating, one or more attributes (reflecting lexical, syntactic, and/or semantic properties of the words of original sentence 212) with each semantic class.

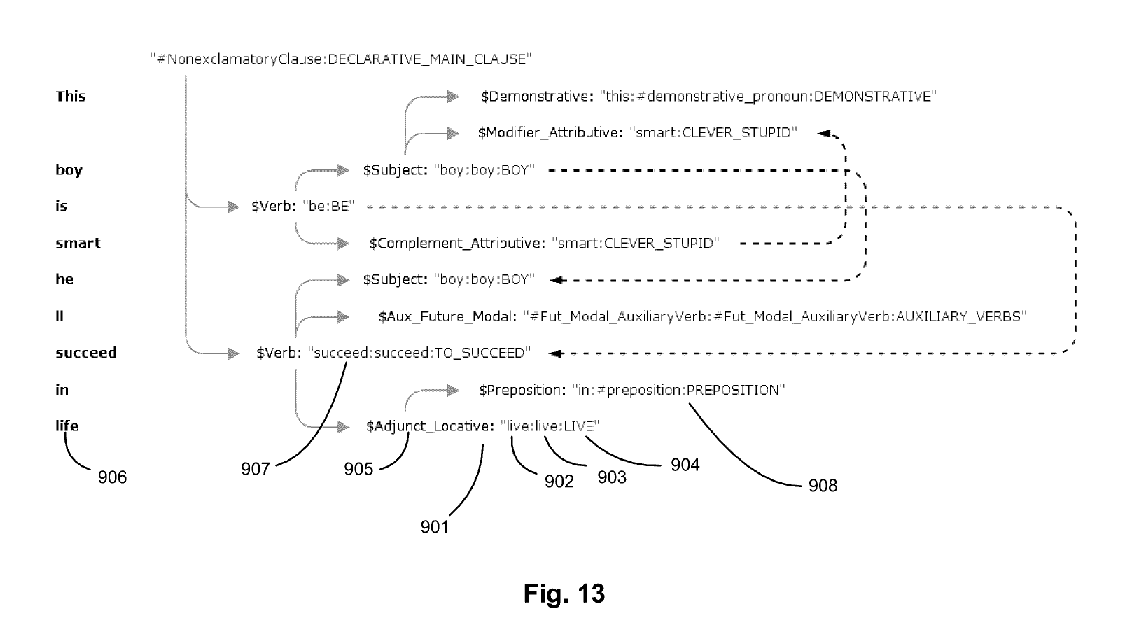

FIG. 13 illustrates an example syntactic structure of a sentence derived from the graph of generalized constituents illustrated by FIG. 12. Node 901 corresponds to the lexical element “life” 906 in original sentence 212. By applying the method of syntactico-semantic analysis described herein, the computing device may establish that lexical element “life” 906 represents one of the lexemes of a derivative form “live” 902 associated with a semantic class “LIVE” 904, and fills in a surface slot $Adjunctr_Locative (905) of the parent constituent, which is represented by a controlling node $Verb:succeed:succeed:TO_SUCCEED (907).

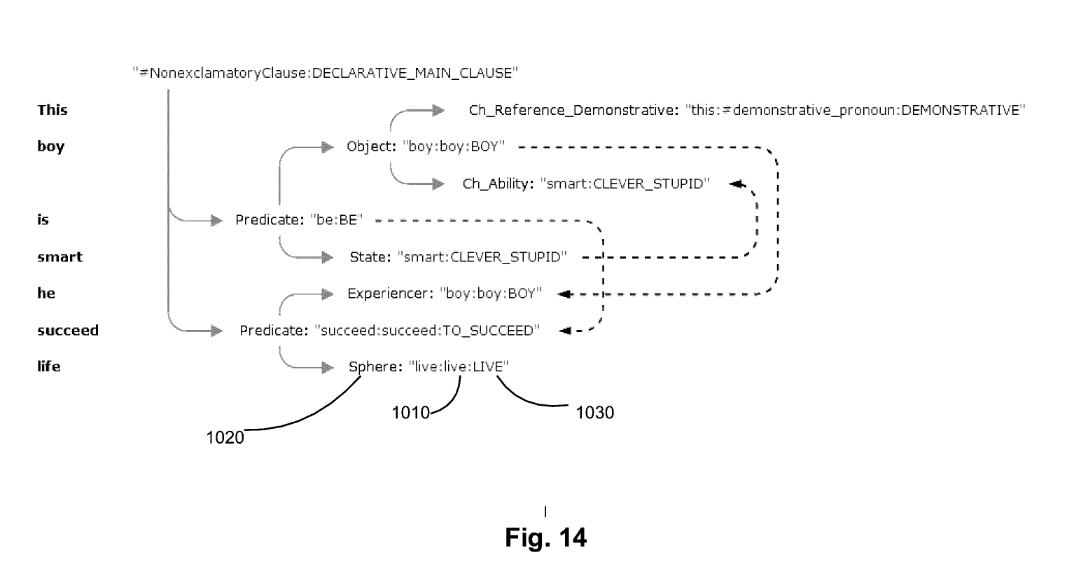

FIG. 14 illustrates a semantic structure corresponding to the syntactic structure of FIG. 13. With respect to the above referenced lexical element “life” 906 of FIG. 13, the semantic structure comprises lexical class 1010 and semantic classes 1030 similar to those of FIG. 13, but instead of surface slot 905, the semantic structure comprises a deep slot “Sphere” 1020.

As noted herein above, and ontology may be provided by a model representing objects pertaining to a certain branch of knowledge (subject area) and relationships among such objects. Thus, an ontology is different from a semantic hierarchy, despite the fact that it may be associated with elements of a semantic hierarchy by certain relationships (also referred to as “anchors”). An ontology may comprise definitions of a plurality of classes, such that each class corresponds to a concept of the subject area. Each class definition may comprise definitions of one or more objects associated with the class. Following the generally accepted terminology, an ontology class may also be referred to as concept, and an object belonging to a class may also be referred to as an instance of the concept.

In accordance with one or more aspects of the present disclosure, the computing device implementing the methods described herein may index one or more parameters yielded by the semantico-syntactic analysis. Thus, the methods described herein allow considering not only the plurality of words comprised by the original text corpus, but also pluralities of lexical meanings of those words, by storing and indexing all syntactic and semantic information produced in the course of syntactic and semantic analysis of each sentence of the original text corpus. Such information may further comprise the data produced in the course of intermediate stages of the analysis, the results of lexical selection, including the results produced in the course of resolving the ambiguities caused by homonymy and/or coinciding grammatical forms corresponding to different lexico-morphological meanings of certain words of the original language.

One or more indexes may be produced for each semantic structure. An index may be represented by a memory data structure, such as a table, comprising a plurality of entries. Each entry may represent a mapping of a certain semantic structure element (e.g., one or more words, a syntactic relationship, a morphological, lexical, syntactic or semantic property, or a syntactic or semantic structure) to one or more identifiers (or addresses) of occurrences of the semantic structure element within the original text.

In certain implementations, an index may comprise one or more values of morphological, syntactic, lexical, and/or semantic parameters. These values may be produced in the course of the two-stage semantic analysis, as described in more details herein. The index may be employed in various natural language processing tasks, including the task of performing semantic search.

The computing device implementing the method may extract a wide spectrum of lexical, grammatical, syntactic, pragmatic, and/or semantic characteristics in the course of performing the syntactico-semantic analysis and producing semantic structures. In an illustrative example, the system may extract and store certain lexical information, associations of certain lexical units with semantic classes, information regarding grammatical forms and linear order, information regarding syntactic relationships and surface slots, information regarding the usage of certain forms, aspects, tonality (e.g., positive and negative), deep slots, non-tree links, semantemes, etc.

The computing device implementing the methods described herein may produce, by performing one or more text analysis methods described herein, and index any one or more parameters of the language descriptions, including lexical meanings, semantic classes, grammemes, semantemes, etc. Semantic class indexing may be employed in various natural language processing tasks, including semantic search, classification, clustering, text filtering, etc. Indexing lexical meanings (rather than indexing words) allows searching not only words and forms of words, but also lexical meanings, i.e., words having certain lexical meanings. The computing device implementing the methods described herein may also store and index the syntactic and semantic structures produced by one or more text analysis methods described herein, for employing those structures and/or indexes in semantic search, classification, clustering, and document filtering.

FIG. 15 illustrates a diagram of an example computing device 1000 which may execute a set of instructions for causing the computing device to perform any one or more of the methods discussed herein. The computing device may be connected to other computing device in a LAN, an intranet, an extranet, or the Internet. The computing device may operate in the capacity of a server or a client computing device in client-server network environment, or as a peer computing device in a peer-to-peer (or distributed) network environment. The computing device may be a provided by a personal computer (PC), a tablet PC, a set-top box (STB), a Personal Digital Assistant (PDA), a cellular telephone, or any computing device capable of executing a set of instructions (sequential or otherwise) that specify operations to be performed by that computing device. Further, while only a single computing device is illustrated, the term “computing device” shall also be taken to include any collection of computing devices that individually or jointly execute a set (or multiple sets) of instructions to perform any one or more of the methodologies discussed herein.

Exemplary computing device 1000 includes a processor 502, a main memory 504 (e.g., read-only memory (ROM) or dynamic random access memory (DRAM)), and a data storage device 518, which communicate with each other via a bus 530.

Processor 502 may be represented by one or more general-purpose computing devices such as a microprocessor, central processing unit, or the like. More particularly, processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 502 may also be one or more special-purpose computing devices such as an application specific integrated circuit (ASIC), a field programmable gate array (FPGA), a digital signal processor (DSP), network processor, or the like. Processor 502 is configured to execute instructions 526 for performing the operations and functions discussed herein.

Computing device 1000 may further include a network interface device 522, a video display unit 510, a character input device 512 (e.g., a keyboard), and a touch screen input device 514.

Data storage device 518 may include a computer-readable storage medium 524 on which is stored one or more sets of instructions 526 embodying any one or more of the methodologies or functions described herein. Instructions 526 may also reside, completely or at least partially, within main memory 504 and/or within processor 502 during execution thereof by computing device 1000, main memory 504 and processor 502 also constituting computer-readable storage media. Instructions 526 may further be transmitted or received over network 516 via network interface device 522.

In certain implementations, instructions 526 may include instructions of method 100 for identifying word collocations in natural language texts, in accordance with one or more aspects of the present disclosure. While computer-readable storage medium 524 is shown in the example of FIG. 15 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining,” “computing,” “calculating,” “obtaining,” “identifying,” “modifying” or the like, refer to the actions and processes of a computing device, or similar electronic computing device, that manipulates and transforms data represented as physical (e.g., electronic) quantities within the computing device's registers and memories into other data similarly represented as physical quantities within the computing device memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
receiving, by a computing device, identifiers of a first plurality of word groups within a natural language text, each word group comprising one or more natural language words;
associating an object represented by each word group with a concept of an ontology;
identifying, within the natural language text, a second plurality of word groups, wherein each word group of the second plurality of word groups is associated with the concept of the ontology;
responsive to receiving a confirmation that a word group of the second plurality of word groups represents an object associated with the concept of the ontology, modifying a parameter of a classification model that produces a value reflecting a degree of association of a given object with the concept of the ontology.

2. The method of claim 1, wherein identifying the second plurality of word groups further comprises:
performing semantico-syntactic analysis of the natural language text to produce a first plurality of semantic structures;
identifying a second plurality of semantic structures, each semantic structure of the second plurality of semantic structures representing a sentence comprising at least one word group of the second plurality of word groups;
identifying, among the first plurality of semantic structures, a semantic structure that is similar to at least one semantic structure of the second plurality of semantic structures in view of a certain similarity metric; and
identifying a word group corresponding to the identified semantic structure from the second plurality of semantic structures as associated with the second plurality of word groups.

3. The method of claim 1, further comprising:
employing the classification model for extracting information from natural language texts.

4. The method of claim 3, further comprising:
utilizing the ontology for performing a natural language processing operation.

5. The method of claim 1, further comprising:
implementing a graphical user interface for receiving identifiers of the first plurality of word groups within a natural language text.

6. The method of claim 1, further comprising: pre-processing the natural language text structure in view of an auxiliary ontology reflecting a document structure associated with the natural language text.

7. The method of claim 1, further comprising:
receiving a second natural language text;
performing semantico-syntactic analysis of the second natural language text;
using the classification model to identify, in view of the semantico-syntactic analysis of the second natural language text, a second semantic structure that represents a second object associated with the concept.

8. The method of claim 7, wherein identifying the second semantic structure further comprises:
determining a plurality of values produced by a classification model, each value reflecting a degree of association of the second semantic structure with a corresponding concept of the ontology;
selecting an optimal value among the determined plurality of values; and
associating the second semantic structure with a concept corresponding to the selected optimal value.

9. A system, comprising:
a memory;
a processor, coupled to the memory, the processor configured to:
receive identifiers of a first plurality of word groups within a natural language text, each word group comprising one or more natural language words;
associate an object represented by each word group with a concept of an ontology;
identify, within the natural language text, a second plurality of word groups, wherein each word group of the second plurality of word groups is associated with the concept of the ontology;
responsive to receiving a confirmation that a word group of the second plurality of word groups represents an object associated with the concept of the ontology, modify a parameter of a classification model that produces a value reflecting a degree of association of a given object with the concept of the ontology.

10. The system of claim 9, wherein to identify the second plurality of word groups, the processor is further configured to:
perform semantico-syntactic analysis of the natural language text to produce a first plurality of semantic structures;
identify a second plurality of semantic structures, each semantic structure of the second plurality of semantic structures representing a sentence comprising at least one word group of the first plurality of word groups;
identify, among the first plurality of semantic structures, a semantic structure that is similar to at least one semantic structure of the second plurality of semantic structures in view of a certain similarity metric; and
identify a word group corresponding to the identified semantic structure as associated with the second plurality of word groups.

11. The system of claim 9, wherein the processor is further configured to:
employ the classification model for expanding the ontology.

12. The system of claim 11, wherein the processor is further configured to:
utilize the ontology for performing a natural language processing operation.

13. The system of claim 1, further comprising:
a graphical user interface for receiving identifiers of the first plurality of word groups within a natural language text.

14. The system of claim 1, wherein the processor is further configured to:
receive a second natural language text;
perform semantico-syntactic analysis of the second natural language text;
use the classification model to identify, in view of the semantico-syntactic analysis of the second natural language text, a second semantic structure that represents a second object associated with the concept.

15. The system of claim 14, to identify the second semantic structure, the processor is further configured to:
determine a plurality of values produced by a classification model, each value reflecting a degree of association of the second semantic structure with a corresponding concept of the ontology;
select an optimal value among the determined plurality of values; and
associate the second semantic structure with a concept corresponding to the selected optimal value.

16. A computer-readable non-transitory storage medium comprising executable instructions that, when executed by a computing device, cause the computing device to:
receive identifiers of a first plurality of word groups within a natural language text, each word group comprising one or more natural language words;
associate an object represented by each word group with a concept of an ontology;
identify, within the natural language text, a second plurality of word groups, wherein each word group of the second plurality of word groups is associated with the concept of the ontology;
responsive to receiving a confirmation that a word group of the second plurality of word groups represents an object associated with the concept of the ontology, modify a parameter of a classification model that produces a value reflecting a degree of association of a given object with the concept of the ontology.

17. The computer-readable non-transitory storage medium of claim 16, wherein executable instructions to identify the second plurality of word groups further comprise executable instructions causing the computing device to:
perform semantico-syntactic analysis of the natural language text to produce a first plurality of semantic structures;
identify a second plurality of semantic structures, each semantic structure of the second plurality of semantic structures representing a sentence comprising at least one word group of the first plurality of word groups;
identify, among the first plurality of semantic structures, a semantic structure that is similar to at least one semantic structure of the second plurality of semantic structures in view of a certain similarity metric; and
identify a word group corresponding to the identified semantic structure as associated with the second plurality of word groups.

18. The computer-readable non-transitory storage medium of claim 16, further comprising executable instructions causing the computing device to:
employ the classification model for expanding the ontology.

19. The computer-readable non-transitory storage medium of claim 18, further comprising executable instructions causing the computing device to:
utilize the ontology for performing a natural language processing operation.
